(19) United States
(12) Patent Application Publication
(10) Pub. No.: US 2025/0372958 A1
(43) Pub. Date: Dec. 4, 2025

(54) SPARK PLUG

(71) Applicant: Niterra Co., Ltd., Nagoya-shi (JP)

(72) Inventors: Mayu FUJISAWA, Nagoya-shi (JP); Kaito NAKAMURA, Nagoya-shi (JP); Kengo HATTORI, Nagoya-shi (JP); Hiroaki IZAWA, Nagoya-shi (JP)

(73) Assignee: Niterra Co., Ltd., Nagoya-shi (JP)

(21) Appl. No.: 19/214,478

(22) Filed: May 21, 2025

(30) Foreign Application Priority Data
May 28, 2024 (JP) 2024-086536

(51) Int. Cl. H01T 13/32; H01T 13/34; H01T 13/39

(52) U.S. Cl. CPC H01T 13/32; H01T 13/34; H01T 13/39

(57) ABSTRACT

A spark plug includes a center electrode and a ground electrode that are electrically insulated from each other. At least one of the center electrode and the ground electrode includes a base material and a chip that is sealed to the base material. The chip contains Ru as a main constituent, faces the other one of the center electrode and the ground electrode, and includes a front end surface at a tip in the thickness direction of the chip, and, in a cross-section passing through the center of gravity of the front end surface and being parallel to the thickness direction of the chip, an average of crystal grain diameters obtained by dividing the length of a test line drawn perpendicularly to the thickness direction of the chip by the number of crystal grains intersected by the test line is 1 μm or more and 50 μm or less.

### FIELD OF THE INVENTION

The present invention relates to a spark plug that includes a chip containing Ru.

### BACKGROUND OF THE INVENTION

Japanese Unexamined Patent Application Publication No. 5-54955 discloses a related art in which at least one of a center electrode and a ground electrode includes a chip constituted by a simple substance of Ru or a Ru alloy.

There is a trend in which mechanical strength of a chip decreases when the material of the chip contains Ru, and cracks may be generated in the chip by a thermal stress.

### SUMMARY OF THE INVENTION

The present invention has been made to solve the above-referenced problem, and an object of the present invention is to provide a spark plug in which generation of cracks in a chip can be reduced.

A first aspect for achieving this object includes an insulator that has an axial hole extending along an axial line; a center electrode that is disposed in the axial hole; a metal shell that is disposed at an outer periphery of the insulator; and a ground electrode that is connected to the metal shell. At least one of the center electrode and the ground electrode includes a base material and a chip that is sealed to the base material. The chip contains Ru as a main constituent, faces another one of the center electrode and the ground electrode, and includes a front end surface at a tip in a thickness direction of the chip, and, in a cross-section passing through a center of gravity of the front end surface and being parallel to the thickness direction of the chip, an average of crystal grain diameters obtained by dividing a length of a test line drawn perpendicularly to the thickness direction of the chip by the number of crystal grains intersected by the test line is 1 μm or more and 50 μm or less.

A second aspect is the first aspect in which the average of the crystal grain diameters is 1 μm or more and 30 μm or less.

The third aspect is the first or second aspect in which, in the cross-section, an average of aspect ratios obtained by dividing a length of each of the crystal grains in a direction parallel to the axial line by a length of each of the crystal grains in a direction perpendicular to the axial line is 0.8 or more and 2.0 or less.

A fourth aspect is the third aspect in which the average of the aspect ratios is 1.0 or more and 2.0 or less.

A fifth aspect is any one of the first to fourth aspects in which a linear expansion coefficient of the base material is 1.0×10⁻⁶K⁻¹ or more and 1.8×10⁻⁶K⁻¹ or less.

According to the present invention, when a test line is drawn perpendicularly to a thickness direction of a chip on a cross-section parallel to the thickness direction of the chip, the average of crystal grain diameters obtained by dividing the length of the test line by the number of crystal grains intersected by the test line is 1 μm or more and 50 μm or less. Since the mechanical strength of the chip can be ensured, it is possible to reduce generation of cracks in the chip.

### BRIEF DESCRIPTION OF THE DRAWINGS

FIG. 1 is a one-side sectional view of a spark plug in a first embodiment.

FIG. 2 is a sectional view of a part where a center electrode and a ground electrode face each other.

FIG. 3 is a sectional view of a chip of a center electrode.

FIG. 4 is a sectional view of crystal grains intersected by a test line.

FIG. 5 is a sectional view of a spark plug in a second embodiment.

FIG. 6 is an enlarged sectional view of the part VI of the spark plug in FIG. 5.

### DETAILED DESCRIPTION OF THE INVENTION

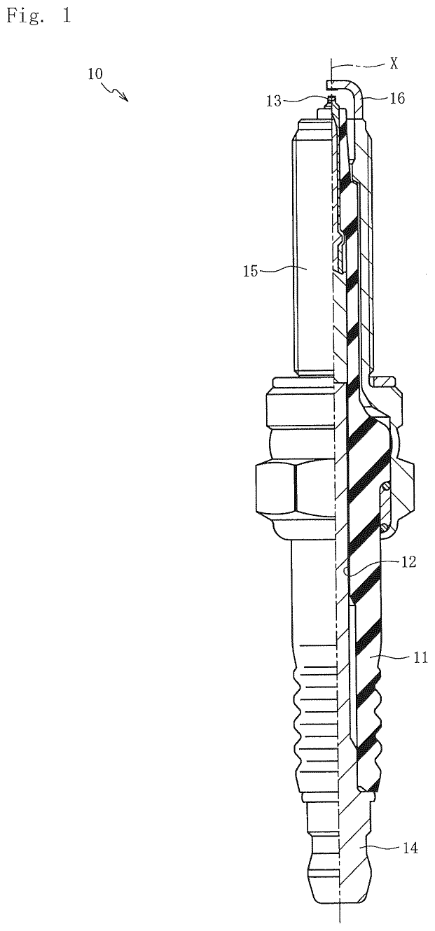

Hereinafter, a preferred embodiment of the present invention will be described with reference to the accompanying drawings. FIG. 1 is a one-side sectional view of a spark plug 10 in the first embodiment with an axial line X as a border. The upper side in FIG. 1 is referred to as the front end side of the spark plug 10, and the lower side in FIG. 1 is referred to as the rear end side of the spark plug 10.

As illustrated in FIG. 1, the spark plug 10 includes an insulator 11, a center electrode 13, a metal shell 15, and a ground electrode 16. The insulator 11 is a substantially cylindrical ceramic member that is made of alumina or the like excellent in mechanical properties and insulation properties under high temperature. The insulator 11 has an axial hole 12 extending along an axial line X through the insulator 11. The center electrode 13 is a rod-shaped electrode disposed along the axial line X in the axial hole 12.

A metal terminal 14 is a rod-shaped member to which an ignition system (not illustrated) is to be connected, and the front end side of the metal terminal 14 is disposed in the axial hole 12 of the insulator 11. The metal terminal 14 is electrically connected to the center electrode 13 in the axial hole 12.

The metal shell 15 is a substantially cylindrical metallic member that is to be fixed to a screw hole (not illustrated) of an internal combustion engine. The metal shell 15 is made of a conductive metal material (for example, low-carbon steel or the like). The metal shell 15 is fixed to the outer periphery of the insulator 11. The ground electrode 16 is connected to the metal shell 15.

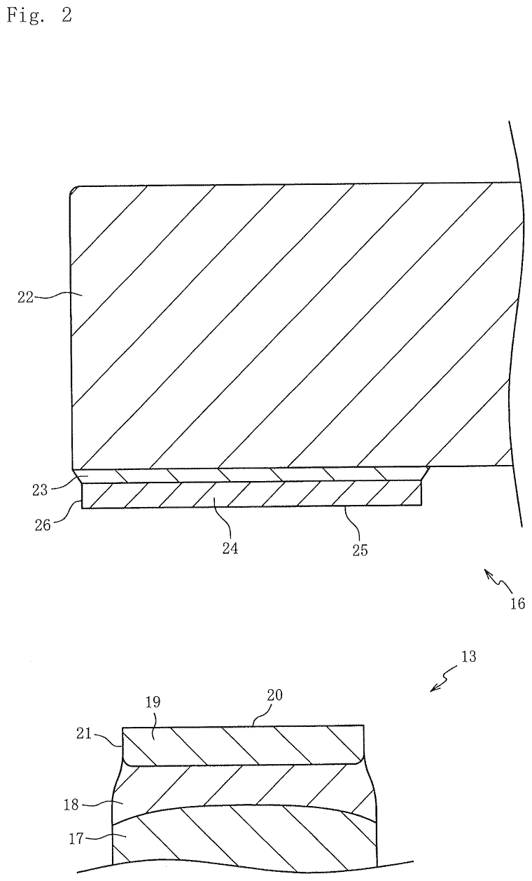

FIG. 2 is a sectional view of a part where the center electrode 13 and the ground electrode 16 of the spark plug 10 face each other. The center electrode 13 includes a base material 17 and a chip 19 that is provided at a tip of the base material 17.

A core material (not illustrated) excellent in thermal conductivity is embedded in the base material 17. The material of the base material 17 is, for example, Ni or an alloy containing Ni as a main constituent, and the material of the core material is, for example, Cu or an alloy containing Cu as a main constituent. The core material can be omitted. The linear expansion coefficient of the base material 17 is 1.0×10⁻⁶K⁻¹ or more and 1.8×10⁻⁶K⁻¹ or less.

The chip 19 is sealed to the base material 17 with a molten portion 18. The chip 19 and the base material 17 have melted in the molten portion 18. The molten portion 18 is formed by laser beam welding, resistance welding, diffusion sealing, or the like. The chip 19 includes a front end surface 20 at a tip in the thickness direction (the up-down direction in FIG. 2) of the chip 19 and a side surface 21 continuous with the front end surface 20.

The ground electrode 16 includes a base material 22 that is connected to the metal shell 15, and a chip 24 that is provided at the base material 22. A core material (not illustrated) excellent in thermal conductivity is embedded in the base material 22. The material of the base material 22 is an alloy containing Ni as a main constituent, and the material of the core material is Cu or an alloy containing Cu as a main constituent. The core material can be omitted. An intermediate member protruding toward the center electrode 13 may be provided at the base material 22, and the chip 24 may be sealed to the intermediate member. The intermediate member is a portion of the base material 22. The linear expansion coefficient of the base material 17 is 1.0×10⁻⁶K⁻¹ or more and 1.8×10⁻⁶K⁻¹ or less.

The chip 24 is sealed to the base material 22 with a molten portion 23. The chip 24 and the base material 22 have melted in the molten portion 23. The molten portion 23 is formed by laser beam welding, resistance welding, diffusion sealing, or the like. The chip 24 includes a front end surface 25 at a tip in the thickness direction (the up-down direction in FIG. 2) of the chip 24 and a side surface 26 continuous with the front end surface 25. In the present embodiment, the front end surface 25 of the chip 24 and the front end surface 20 of the chip 19 face each other, and a spark gap is provided between the front end surface 20 and the front end surface 25.

At least one of the chips 19 and 24 contains Ru as a main constituent. Containing Ru as a main constituent means that, among elements constituting the chip 19 or 24, the element whose content is the largest is Ru. The content of Ru is preferably 50 mass % or more of the amount of all constituents constituting the chip 19 or 24 and is more preferably 60 mass % or more or 70 mass % or more of the amount of the all constituents.

When the chip 19 of the center electrode 13 contains Ru as a main constituent or when the chip 24 of the ground electrode 16 contains Ru as a main constituent, examples of elements other than Ru constituting the chip 19 or 24 are one or more elements selected from Rh, Pd, Os, Ir, Pt, Ta, W, Mo, Nb, Re, Cr, Mn, Fe, Co, Ni, V, Ti, Zr, Hf, Al, and Sc.

When the chip 19 of the center electrode 13 contains Ru as a main constituent, the ground electrode 16 is any one of a ground electrode that includes the chip 24 containing Ru as a main constituent, a ground electrode that includes the chip 24 containing as main constituents one or more of platinum group elements (Rh, Pd, Os, Ir, Pt) other than Ru, and a ground electrode in which the molten portion 23 and the chip 24 are not provided at the base material 22.

When the chip 24 of the ground electrode 16 contains Ru as a main constituent, the center electrode 13 is any one of a center electrode that includes the chip 19 containing Ru as a main constituent, a center electrode that includes the chip 19 containing as main constituents one or more of platinum group elements (Rh, Pd, Os, Ir, Pt) other than Ru, and a center electrode in which the molten portion 18 and the chip 19 are not provided at the base material 17.

The spark plug 10 is formed by, for example, the following method. First, the center electrode 13 is inserted into the axial hole 12 of the insulator 11. Next, after the metal terminal 14 is inserted into the axial hole 12 and electrical continuity between the metal terminal 14 and the center electrode 13 is ensured, the metal shell 15 to which the ground electrode 16 is previously connected is assembled to the outer periphery of the insulator 11. The ground electrode 16 is bent to form a spark gap between the center electrode 13 and the ground electrode 16, thereby obtaining the spark plug 10.

The chips 19 and 24 containing Ru as a main constituent are each formed by, for example, sintering a molded body of metal powder containing Ru, punching a metal plate material containing Ru, or cutting a metal wire material containing Ru. The shape of each of the chips 19 and 24 is not limited, and examples of the shape are shapes of a circular plate, a truncated cone, an elliptical cylinder, and polygonal cylinders such as a triangular cylinder and a quadrangular cylinder.

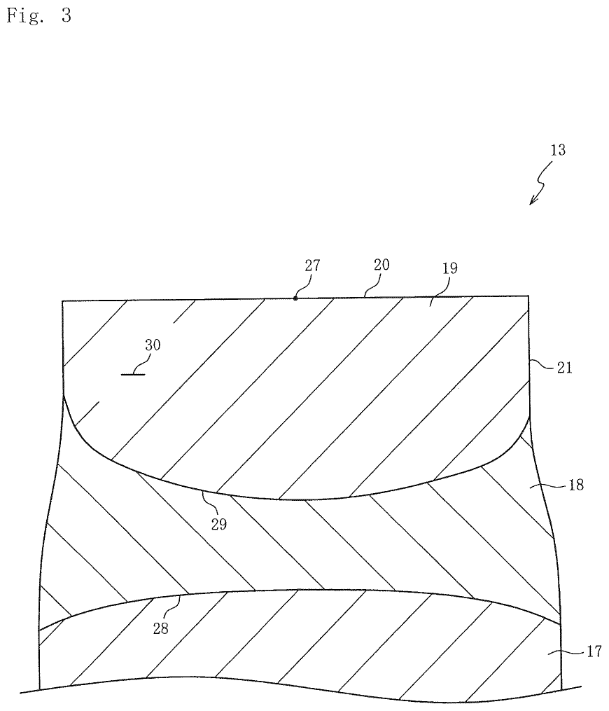

FIG. 3 is a sectional view of the chip 19 of the center electrode 13. In the sectional view in FIG. 3, an example of a scanning electron microscopic (SEM) image of a polished surface of the chip 19 cut parallel to the thickness direction of the chip 19 at the position of a gravity center 27 of the front end surface 20 is illustrated. In the present embodiment, the thickness direction of the chip 19 coincides with a direction in which the axial line X extends. The gravity center 27 of the front end surface 20 is a centroid when the front end surface 20 is illustrated as a plane diagram. An interface 28 between the base material 17 and the molten portion 18 and an interface 29 between the molten portion 18 and the chip 19 appear in the cross-section.

For observation of a sectional structure of the chip 19, a test line 30 (straight line) is drawn perpendicularly (parallel to the front end surface 20) to the thickness direction of the chip 19. At least a distance of 10 μm is provided between the front end surface 20 and the test line 30 instead of drawing the test line on the front end surface 20 since the cross-section of the chip 19 on the front end surface 20 is deformed (rounded) and decreases accuracy of observation of the sectional structure.

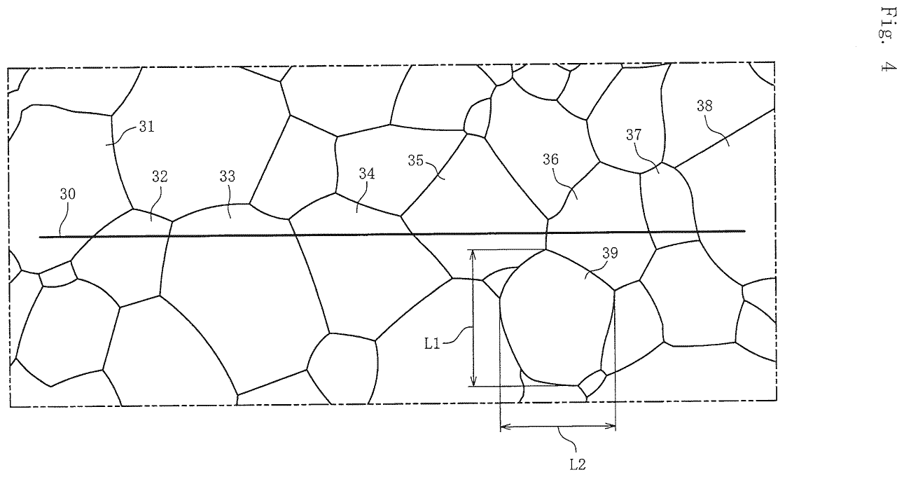

FIG. 4 is a sectional view of crystal grains intersected by the test line 30. The number of the crystal grains intersected by the test line 30 is counted. In the present embodiment, the test line 30 drawn on the cross-section of the chip 19 intersects crystal grains 32, 33, 34, 35, 36, and 37 (6 pieces). The two ends of the test line 30 end in crystal grains 31 and 38, respectively. Two end portions of the test line 30 are each counted to be considered to intersect ½ of the crystal grain 31 or 38. Therefore, the number of the crystal grains intersected by the test line 30 is (6+2× ½) pieces=7 pieces.

The length of the test line 30 is set such that the test line 30 intersects ten or more pieces of crystal grains. The test line 30 is randomly drawn at various positions in a range that satisfies a condition in which the test line 30 is perpendicular to the thickness direction of the chip 19, and the number of crystal grains intersected by the test line 30 is counted a plurality of times to obtain an average value of the numbers. The length of the test line 30 may be changed in each count. The length of the test line 30 used in measurement is divided by the average value (the number of crystal grains), thereby obtaining an average of crystal grain diameters (μm). The average of the crystal grain diameters of the chip 19 is 1 μm or more and 50 μm or less and is preferably 1 μm or more and 30 μm or less.

When the average of the crystal grain diameters of the chip 19 is in the range of 1 μm to 50 μm, the proportion of crystal grain boundaries between the crystal grains increases relatively, compared with when the average of the crystal grain diameters exceeds 50 μm, and causes dislocations not to move easily, and it is thus possible to improve the mechanical strength of the chip 19. Consequently, it is possible to reduce generation of cracks in the chip 19 due to a thermal stress.

An average of aspect ratios L1/L2 obtained by dividing a length L1 of the crystal grain 39 of the chip 19 in a direction parallel to the axial line X (refer to FIG. 1) by a length L2 of the crystal grain 39 in a direction perpendicular to the axial line is preferably 0.8 or more and 2.0 or less and is preferably in particular 1.0 or more and 2.0 or less. This is because thermal strain generated in the chip 19 due to a temperature change during a use of the spark plug 10 is easily absorbed by a deformation of the crystal grain, and occurrence of fracture of crystal grain boundaries can be reduced. Consequently, it is possible to further reduce generation of cracks in the chip 19.

The linear expansion coefficient of the base material 17 (refer to FIG. 3) is preferably 1.0×10⁻⁶K⁻¹ or more and 1.8×10⁻⁶K⁻¹ or less. This is because a difference between the linear expansion coefficient of the chip 19 containing Ru and the linear expansion coefficient of the base material 17 can be reduced, and it is thus possible to reduce occurrence of fracture of the interface 28 between the base material 17 and the molten portion 18 and the interface 29 between the molten portion 18 and the chip 19 due to a temperature change during a use of the spark plug 10.

When the chip 24 of the ground electrode 16 (refer to FIG. 2) contains Ru as a main constituent, an average of crystal grain diameters obtained by drawing a test line perpendicularly (parallel to the front end surface 25) to the thickness direction of the chip 24 and dividing the length of the test line by the number of crystal grains intersected by the test line is preferably 1 μm or more and 50 μm or less and is more preferably 1 μm or more and 30 μm or less. Conditions relating to the aspect ratio of each crystal grain of the chip 24 and the linear expansion coefficient of the base material 22 are the same as the conditions described for the center electrode 13.

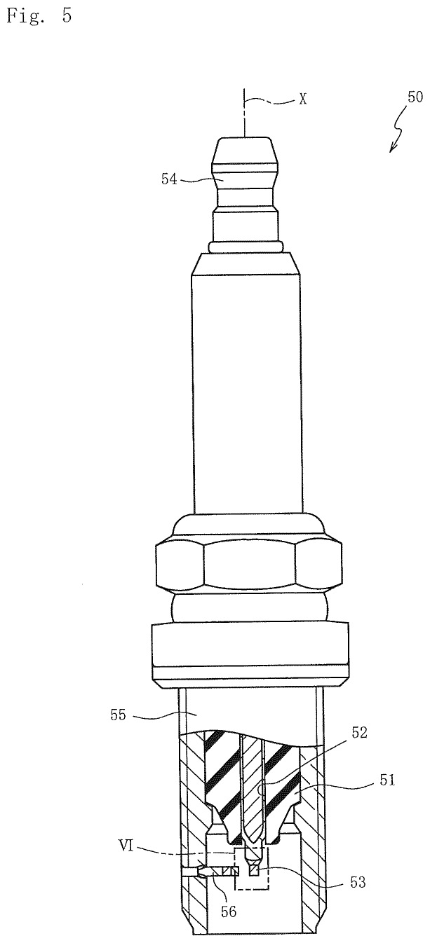

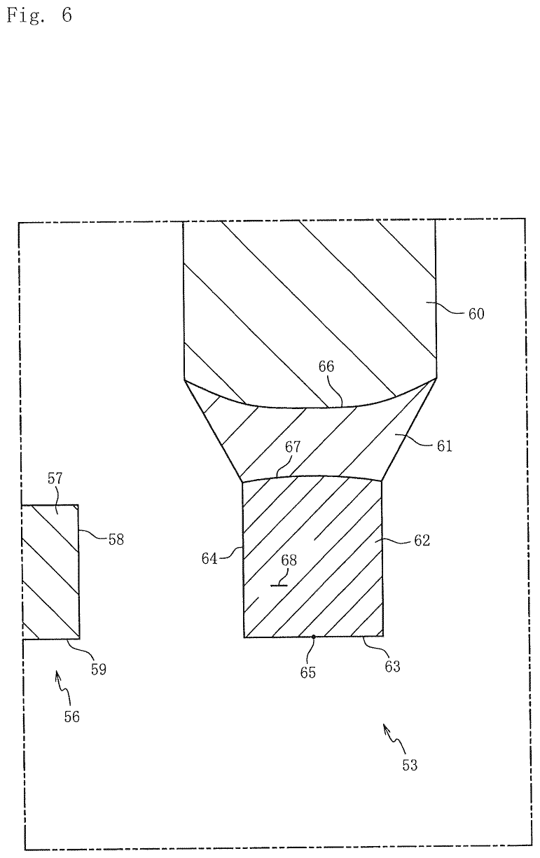

With reference to FIG. 5 and FIG. 6, a second embodiment will be described. The first embodiment in which the front end surface 20 of the chip 19 of the center electrode 13 faces the front end side in a direction parallel to the axial line X and in which the front end surface 25 of the chip 24 of the ground electrode 16 faces the rear end side in the direction parallel to the axial line X has been described. In contrast, the second embodiment in which a front end surface 63 of a chip 62 of a center electrode 53 faces the front end side in the direction parallel to the axial line X and in which a front end surface 58 of a chip 57 of a ground electrode 56 faces a side in a direction perpendicular to the axial line X will be described.

FIG. 5 is a sectional view of a spark plug 50 in the second embodiment. The lower side in FIG. 5 is referred to as the front end side of the spark plug 50, and the upper side in FIG. 5 is referred to as the rear end side of the spark plug 50. In FIG. 5, illustration of a cross-section of the rear end side of the spark plug 50 is omitted.

As illustrated in FIG. 5, the spark plug 50 includes an insulator 51, the center electrode 53, a metal shell 55, and the ground electrode 56. The insulator 51 is a substantially cylindrical ceramic member that is made of alumina or the like excellent in mechanical properties and insulation properties under high temperature. The insulator 11 has an axial hole 52 extending along the axial line X through the insulator 11. The center electrode 53 is a rod-shaped electrode disposed along the axial line X in the axial hole 12.

A metal terminal 54 is a rod-shaped member to which an ignition system (not illustrated) is to be connected, and the metal terminal 54 is electrically connected to the center electrode 53 in the axial hole 52. The metal shell 55 is a substantially cylindrical metallic (for example, low-carbon steel or the like) member that is to be fixed to a screw hole (not illustrated) of an internal combustion engine. The metal shell 55 is fixed to the outer periphery of the insulator 51. The ground electrode 56 is connected to the metal shell 55.

FIG. 6 is an enlarged sectional view of the part VI of the spark plug 50 in FIG. 5. The ground electrode 56 includes a rod-shaped base material (not illustrated) and the chip 57 that is sealed to a tip of the base material. The chip 57 includes the front end surface 58 that is at a tip in the thickness direction of the chip 57 and that faces the center electrode 53, and a side surface 59 that is continuous with the front end surface 58.

The center electrode 53 includes a base material 60 and the chip 62 provided at a tip of the base material 60. The chip 62 contains Ru as a main constituent. The chip 62 is sealed to the base material 60 with a molten portion 61. The chip 62 and the base material 60 have melted in the molten portion 61. The chip 62 includes the front end surface 63 at a tip in the thickness direction of the chip 62, and a side surface 64 continuous with the front end surface 63. The side surface 64 of the chip 62 and the front end surface 58 of the chip 57 face each other in the direction perpendicular to the axial line X (refer to FIG. 5).

In the sectional view in FIG. 6, an example of a SEM image of a polished surface of the chip 62 cut parallel to the thickness direction of the chip 62 at the position of a gravity center 65 of the front end surface 63 is illustrated. The shape of the chip 62 is not limited. An interface 66 between the base material 60 and the molten portion 61 and an interface 67 between the molten portion 61 and the chip 62 appear in the cross-section.

For observation of a sectional structure of the chip 62, a test line 68 (straight line) is drawn perpendicularly (parallel to the front end surface 63) to the thickness direction of the chip 62. An average of crystal grain diameters of the chip 62 obtained by dividing the length of the test line by the number of crystal grains intersected by the test line is preferably 1 μm or more and 50 μm or less and is more preferably 1 μm or more and 30 μm or less. Consequently, it is possible to reduce generation of cracks in the chip 62. Conditions relating to the aspect ratio of each crystal grain of the chip 62 and the linear expansion coefficient of the base material 60 are the same as the conditions described in the first embodiment.

When the chip 57 of the ground electrode 56 contains Ru as a main constituent, an average of crystal grain diameters obtained by drawing a test line perpendicularly (parallel to the front end surface 58) to the thickness direction of the chip 57 and dividing the length of the test line by the number of crystal grains intersected by the test line is preferably 1 μm or more and 50 μm or less and is more preferably 1 μm or more and 30 μm or less. Conditions relating to the aspect ratio of each crystal grain of the chip 57 and the linear expansion coefficient of the base material (not illustrated) are the same as the conditions described in the first embodiment.

### Example

The present invention will be described more specifically with an example. The present invention is, however, not limited to the example.

An examiner produced cylindrical chips by powder-metallurgy processing using metal powder containing Ru. The dimensions of each chip were set to a diameter of 0.6 mm and a height of 0.5 mm. Various chips having different compositions and different structures were obtained by varying the material and the particle-diameter distribution of the metal powder and sintering temperature. In addition, various chips having different aspect ratios were obtained by varying pressurizing conditions for sintering.

The examiner prepared various base materials having different linear expansion coefficients by varying the composition of a Ni-based alloy and produced various center electrodes in each of which a chip is sealed to the base material by laser beam welding. The examiner produced each of a plurality of samples No. 1 to No. 42 of a spark plug that is the same as the first embodiment in which a spark gap is provided between a chip of a center electrode and a ground electrode.

After obtained a SEM image of a cross-section of the chip of each of the samples No. 1 to No. 42, the cross-section passing through the center of gravity of a front end surface of the chip and being parallel to an axial line, the examiner counted, at a plurality of positions, the number of crystal grains intersected by a test line parallel to the front end surface. An average (μm) of crystal grain diameters was calculated by dividing the length of the test line by the number of crystal grains to obtain a result and rounding the result to one decimal place. The average of aspect ratios L1/L2 of crystal grains was calculated from the SEM image. The magnification of the SEM image was set in a range of 500 to 2000 times, as appropriate, in accordance with the sizes of the crystal grains of the samples.

The examiner mounted, among the samples No. 1 to No. 42, each of samples other than samples for each of which a SEM image had been obtained on an engine (type: L13A) and conducted a test in which an ignition system is connected to the sample, spark discharge is generated between the center electrode and the ground electrode, and the engine is operated for 100 hours at an engine revolution of 5000 rpm. The energy supplied for single spark discharge to each sample from the ignition system was 100 mJ, the air/fuel ratio in the test was 10.5, the pressure in a combustion chamber of the engine was 60 kPa, and the temperature of each chip was 600° C. The temperature of each chip was measured with temperature measuring junctions of a thermocouple arranged near the chip before the test was started. After the test, each of the samples No. 1 to No. 42 was dismounted from the engine, and, at the position of the center of gravity of the front end surface of the chip of the center electrode, the chip and the base material were cut parallel to the axial line from each other.

### Judgment 1

A cut section of each chip was observed with a metallurgical microscope, and the length of each crack in the radial direction of the chip was measured. The chips in each of which no crack was generated were judged as A, the chips in each of which the length of each crack was less than 25% of the diameter of the chip were judged as B, the chips in each of which the length of each crack was 25% or more and less than 50% of the diameter of the chip were judged as C, and the chips in each of which the length of each crack was 50% or more of the diameter of the chip were judged as D.

### Judgment 2

An interface of the molten portion was observed with a metallurgical microscope, and the length of each crack generated at the interface was measured. The chips in each of which the length of each crack was less than 10 μm were judged as A, and the chips in each of which the length of each crack was 10 μm or more were judged as D. The compositions of the chips, the crystal grain diameters of the chips, the aspect ratios of the crystal grains, the linear expansion coefficients of the base materials, and results of the judgment 1 and the judgment 2 are shown in Table 1.

TABLE 1

| | chip | | | base material | | |
|---|---|---|---|---|---|---|
| | | crystal | | linear | | |
| | | grain | aspect | expansion | judg- | judg- |
| | | diameter | ratio | coefficient | ment | ment |
| No. | composition | (μm) | (—) | (×10⁻⁶/K) | 1 | 2 |
| 1 | Ru | 1 | 1.2 | 1.0 | A | A |
| 2 | | 9 | 1.5 | 1.1 | B | A |
| 3 | | 30 | 0.8 | 1.0 | A | A |
| 4 | | 31 | 1.1 | 1.7 | B | A |
| 5 | | 44 | 0.7 | 1.3 | C | A |
| 6 | | 50 | 1.3 | 1.5 | C | A |
| 7 | | 51 | 1.2 | 1.9 | D | D |
| 8 | Ru—5Pt | 6 | 1.0 | 1.8 | A | A |
| 9 | | 11 | 1.3 | 1.7 | B | A |
| 10 | | 29 | 0.7 | 1.6 | B | A |
| 11 | | 33 | 1.2 | 1.3 | B | A |
| 12 | | 35 | 0.8 | 1.7 | B | A |
| 13 | | 49 | 1.0 | 1.3 | B | A |
| 14 | | 53 | 0.9 | 1.2 | D | A |
| 15 | Ru—15Pt | 3 | 1.0 | 1.8 | A | A |
| 16 | | 12 | 0.9 | 1.8 | A | A |
| 17 | | 21 | 1.0 | 1.9 | A | D |
| 18 | | 38 | 1.1 | 1.1 | B | A |
| 19 | | 42 | 1.6 | 1.3 | C | A |
| 20 | | 48 | 1.4 | 1.3 | C | A |
| 21 | | 59 | 1.4 | 0.9 | D | D |
| 22 | Ru—30Pt | 1 | 2.1 | 2.0 | B | D |
| 23 | | 17 | 2.0 | 1.0 | B | A |
| 24 | | 26 | 1.4 | 1.1 | B | A |
| 25 | | 30 | 1.0 | 1.7 | A | A |
| 26 | | 31 | 1.1 | 1.5 | B | A |
| 27 | | 50 | 1.4 | 1.5 | C | A |
| 28 | | 55 | 1.2 | 1.8 | D | A |
| 29 | Ru—10Ni | 8 | 0.6 | 1.2 | B | A |
| 30 | | 10 | 1.2 | 1.4 | A | A |
| 31 | | 22 | 0.3 | 1.4 | B | A |
| 32 | | 23 | 1.9 | 1.3 | B | A |
| 33 | | 34 | 1.1 | 1.2 | B | A |
| 34 | | 41 | 1.6 | 1.1 | C | A |
| 35 | | 56 | 1.4 | 1.2 | D | A |
| 36 | Ru—6Co | 3 | 1.1 | 2.0 | A | D |
| 37 | | 4 | 0.8 | 1.5 | A | A |
| 38 | | 15 | 0.9 | 1.6 | A | A |
| 39 | | 23 | 1.7 | 2.1 | B | D |
| 40 | | 29 | 1.3 | 1.7 | B | A |
| 41 | | 42 | 1.3 | 1.8 | C | A |
| 42 | | 47 | 1.5 | 1.9 | C | D |

According to Table 1, the samples No. 1 to No. 6, No. 8 to No. 13, No. 15 to No. 20, No. 22 to No. 27, No. 29 to No. 34, and No. 36 to No. 42 in each of which the average of the crystal grain diameters was 1 μm or more and 50 μm or less were judged as A, B or C in the judgment 1 while the samples No. 7, No. 14, No. 21, No. 28, and No. 35 in each of which the average of the crystal grain diameters was larger than 50 μm were judged as D in the judgment 1. Therefore, it was found that generation of cracks can be reduced in the chips in each of which the average of the crystal grain diameters was 1 μm or more and 50 μm or less.

The samples No. 1 to No. 3, No. 8 to No. 10, No. 15 to No. 17, No. 22 to No. 25, No. 29 to No. 32, and No. 36 to No. 40 in each of which the average of the crystal grain diameters was 1 μm or more and 30 μm or less were judged as A or B in the judgment 1 while the samples No. 4 to No. 6, No. 11 to No. 13, No. 18 to No. 20, No. 26, No. 27, No. 33, No. 34, No. 41, and No. 42 in each of which the average of the crystal grain diameters was larger than 30 μm and less than or equal to 50 μm were judged as B or C in the judgment 1. Therefore, it was found that generation of cracks can be further reduced in the chips in each of which the average of the crystal grain diameters was 1 μm or more and 30 μm or less.

Comparing the samples No. 4 and No. 5, the aspect ratio in the sample No. 4 was 1.1 and the sample No. 4 was judged as B in the judgment 1 while the aspect ratio in the sample No. 5 was 0.7 and the sample No. 5 was judged as C in the judgment 1. Comparing the samples No. 29 to No. 31, the aspect ratio in the sample No. 30 was 1.2 and the sample No. 30 was judged as A in the judgment 1. Meanwhile, the aspect ratio in the sample No. 29 was 0.6 and the sample No. 29 was judged as B in the judgment 1, and the aspect ratio in the sample No. 30 was 0.3 and the sample No. 30 was judged as B in the judgment 1. Consequently, it was found that generation of cracks can be further reduced in the chips when the aspect ratio is 0.8 or more and 2.0 or less.

The samples No. 1 to No. 6, No. 8 to No. 16, No. 18 to No. 20, No. 23 to No. 35, No. 37, No. 38, No. 40, and No. 41 in each of which the linear expansion coefficient of the base material was 1.0×10⁻⁶K⁻¹ or more and 1.8×10⁻⁶K⁻¹ or less were judged as A in the judgment 2 while the samples No. 7, No. 17, No. 21, No. 22, No. 36, No. 39, and No. 42 in each of which the linear expansion coefficient of the base material was less than 1.0×10⁻⁶K⁻¹ or greater than 1.8×10⁻⁶K⁻¹ were judged as D in the judgment 2. Therefore, it was found that cracks at the interface of the molten portion can be reduced when the linear expansion coefficient of the base material was 1.0×10⁻⁶K⁻¹ or more and 1.8×10⁻⁶K⁻¹ or less.

Although the present invention has been described above on the basis of the embodiments, it can be easily assumed that the present invention is not limited at all to the aforementioned embodiments and can be variously improved or modified within a range that does not deviate from the gist of the present invention.

Although the first embodiment in which the ground electrode 16 is bent has been described, the present invention is not limited thereto. It is naturally possible to use, as an alternative to the bent ground electrode 16, the ground electrode 16 having a linear shape. In this case, the front end side of the metal shell 15 is extended in the axial line direction, and the linear ground electrode 16 is sealed to the metal shell 15. The number of the ground electrodes 16 is also set, as appropriate.

Although the second embodiment in which the linear ground electrode 56 is used has been described, the present invention is not limited thereto. It is naturally possible to use, as an alternative to the linear ground electrode 56, the ground electrode 56 that is bent. The number of the ground electrodes 56 is also set, as appropriate. It is naturally possible to cover the front end side of the metal shell 55 with a plug cap having a hole extending through the cap in the thickness direction.

### DESCRIPTION OF REFERENCE NUMERALS

10, 50 spark plug
11, 51 insulator
12, 52 axial hole
13, 53 center electrode
15, 55 metal shell
16, 56 ground electrode
17, 60 base material
19, 62 chip
20, 63 front end surface
27, 65 gravity center
30, 68 test line
L1, L2 length
X axial line

What is claimed is:

1. A spark plug comprising:
an insulator that has an axial hole extending along an axial line;
a center electrode that is disposed in the axial hole;
a metal shell that is disposed at an outer periphery of the insulator; and
a ground electrode that is connected to the metal shell,
wherein at least one of the center electrode and the ground electrode includes a base material and a chip that is sealed to the base material,
wherein the chip contains Ru as a main constituent and faces another one of the center electrode and the ground electrode,
wherein the chip includes a front end surface at a tip in a thickness direction of the chip, and
wherein, in a cross-section passing through a center of gravity of the front end surface and being parallel to the thickness direction of the chip, an average of crystal grain diameters obtained by dividing a length of a test line drawn perpendicularly to the thickness direction of the chip by the number of crystal grains intersected by the test line is 1 μm or more and 50 μm or less.

2. The spark plug according to claim 1,
wherein the average of the crystal grain diameters is 1 μm or more and 30 μm or less.

3. The spark plug according to claim 1,
wherein, in the cross-section, an average of aspect ratios obtained by dividing a length of each of the crystal grains in a direction parallel to the axial line by a length of each of the crystal grains in a direction perpendicular to the axial line is 0.8 or more and 2.0 or less.

4. The spark plug according to claim 3,
wherein the average of the aspect ratios is 1.0 or more and 2.0 or less.

5. The spark plug according to claim 1,
wherein a linear expansion coefficient of the base material is 1.0×10⁻⁶K⁻¹ or more and 1.8×10⁻⁶K⁻¹ or less.
